(19) United States
(12) Patent Application Publication
(10) Pub. No.: US 2010/0006595 A1
(43) Pub. Date: Jan. 14, 2010

(54) VACUUM SPRAY COATING OF LUBRICANT FOR MAGNETIC RECORDING MEDIA

(75) Inventors: Xiaoding Ma, Fremont, CA (US); Michael Joseph Stirniman, Fremont, CA (US); Jiping Yang, San Jose, CA (US); Jing Gui, Fremont, CA (US)

Correspondence Address: MURABITO, HAO & BARNES, LLP, TWO NORTH MARKET STREET, THIRD FLOOR, SAN JOSE, CA, 95113, US

(73) Assignee: Seagate Technology LLC, Scotts Valley, CA (US)

(21) Appl. No.: 12/171,710

(22) Filed: Jul. 11, 2008

(51) Int. Cl. B67D 5/04

(52) U.S. Cl. 222/3; 222/1

(57) ABSTRACT

Processing equipment for manufacturing magnetic recording medium comprising a chamber, a micro-dispensing valve that can open for a minimum time of less than a few microseconds and can dispense a liquid in an amount of a micro-liter or less each time that the micro-dispensing valve is opened, wherein the liquid comprising a lubricant and a solvent different from the lubricant is dispensed through the micro-dispensing valve.

### BACKGROUND

Magnetic discs with magnetizable media are used for data storage in most all computer systems. Current magnetic hard disc drives operate with the read-write heads only a few nanometers above the disc surface and at rather high speeds, typically a few meters per second. Because the read-write heads can contact the disc surface during operation, a layer of lubricant is coated on the disc surface to reduce wear and friction.

FIG. 1 shows a disk recording medium and a cross section of a disc showing the difference between longitudinal and perpendicular recording. Even though FIG. 1 shows one side of the non-magnetic disk, magnetic recording layers are sputter deposited on both sides of the non-magnetic aluminum substrate of FIG. 1. Also, even though FIG. 1 shows an aluminum substrate, other embodiments include a substrate made of glass, glass-ceramic, NiP/aluminum, metal alloys, plastic/polymer material, ceramic, glass-polymer, composite materials or other non-magnetic materials.

Generally, the lubricant is applied to the disc surface by dipping the disc in a bath containing the lubricant. The bath typically contains the lubricant and a coating solvent to improve the coating characteristics of the lubricant, which is usually viscous oil. The discs are removed from the bath, and the solvent is allowed to evaporate, leaving a layer of lubricant on the disc surface.

The lubricant film on hard discs provides protection to the underlying magnetic alloy by preventing wear of the carbon overcoat. In addition, it works in combination with the overcoat to provide protection against corrosion of the underlying magnetic alloy.

In vapor phase lubrication process, the lube vapor was generated in the vacuum by heating the lube to a certain temperature and then the lubricant vapor was condensed onto discs with carbon overcoat. Deposition rate was controlled by liquid lubricant heater temperature. Comparing to traditional dip-coat lubrication process, vapor phase lubrication by lubricant evaporation has certain advantages, such as solvent-free process, uniform lube thickness without the lube feature associated with dip-lube process, etc. However, there is one disadvantage for current vapor lubrication process. Since the lubricants currently used are Perfluoropolyethers (PFPEs) which have a certain molecular weight (MW) distribution (polydispersity index>1), the lower MW components will evaporate first. In order to maintain the fixed deposition rate, the lube heating temperature will be slowly increased. As a result, the MW of lube deposited on discs is gradually shifted from low to high, comparing to the fixed MW distribution for dip-lube process. Since the MW of lubes affects the properties of lube, such as viscosity, surface mobility, lube pickup, etc., there would be a HDI performance shift over the lube usage in the disc manufacturing. In addition, to achieve the desired reliability performance, two or more different types of lubes with certain ratio are coated onto the disk surfaces. This is hard to realize with the current vapor lube system, since different types of lubes have the different vapor pressures. Therefore, to obtain a fixed MW distribution and multi-component lubes on discs over the production is highly desired.

### SUMMARY OF THE INVENTION

The present invention relates to an equipment and method for deposition of lubricant film on storage medium using micro-dispensing valve atomization.

The invention relates a process and an apparatus for deposition of lubricant film on storage medium using micro-dispensing valve atomization having a high-speed micro-dispensing valve and, thereby, creating a surface of the storage medium having a lubricant layer having a uniform composition of the lubricant throughout the lubricant layer. An embodiment of the invention relates to processing equipment for manufacturing magnetic recording medium comprising a chamber, a micro-dispensing valve that can open for a minimum time of less than 0.3 microseconds and can dispense a liquid in an amount of about 100 nanoliter- to about 500 micro-liter each time that the micro-dispensing valve is opened, wherein the liquid comprising a lubricant and a solvent different from the lubricant is dispensed through the micro-dispensing valve. These and various other features and advantages will be apparent from a reading of the following detailed description.

### BRIEF DESCRIPTION OF THE DRAWINGS

The present invention will be better understood by reference to the Detailed Description of the Invention when taken together with the attached drawings, wherein:

FIG. 1 shows a magnetic recording medium.

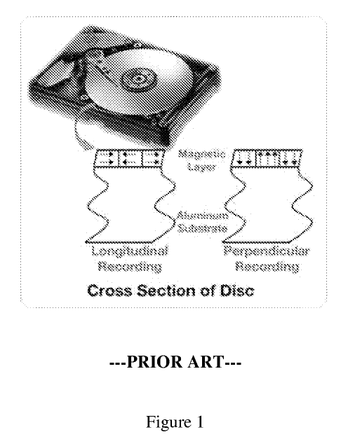

FIG. 2 shows an inline process for manufacturing magnetic recording media.

FIG. 3 shows a schematic of an apparatus for the deposition of lubricant film on storage medium using micro-dispensing valve atomization.

FIG. 4 shows a HDI surface scan of a 95 mm disk surface after the vacuum spray of the solution of 0.005 wt % Zdol-TX in Vertrel XF with pulse duration 5 sec.

### DETAILED DESCRIPTION OF THE INVENTION

The invention is directed to a method of coating a substrate, particularly recording media (recording discs), with a lubricant, which is also referred in the specification to as a “lube.” Lubricants typically contain molecular weight components that range from several hundred Daltons to several thousand Daltons.

One of the approaches to improve medium corrosion resistance is vapor lube process, in which the lubricant is deposited on the medium under vacuum condition right after deposition of carbon overcoat. This approach is based on the idea that corrosion is retarded if the medium is protected by lubricant before being exposed to the atmospheric environment. The vapor lube process includes vapor deposition of perfluoropolyether (PFPE) lubricants on a medium. In this process, the lubricant is vaporized by evaporation of PFPE lubricants at elevated temperature. During the course of this invention, the inventors recognized some problems associated with the thermal evaporation process.

First, the thermal vaporization is dependent on the molecular weight of the lubricant. Lower molecule weight lubricant molecules have higher vapor pressure and evaporate faster than lubricants of higher molecular weight. This difference in the evaporation rate causes a continuous drift of the lubricant molecular weight of the lubricant deposited on a medium over a process time. Moreover, a constant deposition rate was found to be hard to maintain, and the vaporization temperature had to be raised continuously with processing time. In addition, since the lube bath was maintained at an elevated temperature, thermal degradation of the lube could occur over a period of time.

Second, thermal vapor lubing of multiple-component lubricant system was found to be difficult. Nowadays, lubricant additives, such as Bis(4-fluorophenoxy)-tetrakis(3-trifluoromethyl phenoxy)cyclotriphosphazene (X1P), are widely used to improve tribological performance of film media. Such a multiple component system would require multiple vapor lube stations to deposit the lubricant(s) and additive(s) sequentially. Yet, the thickness of each component layer was difficult to control.

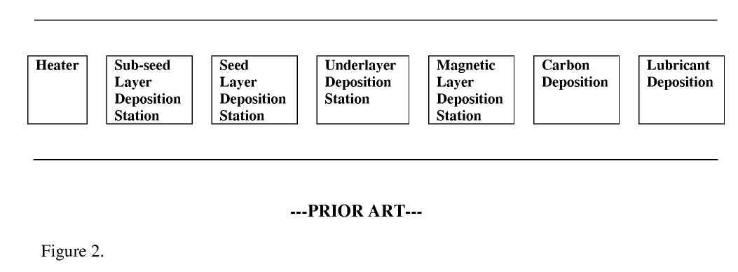

An inline process for manufacturing magnetic recording media is schematically illustrated in FIG. 2. The media substrates travel sequentially from the heater to a sub-seed layer deposition station and a sub-seed layer is formed on the media substrates. Then, the media substrates travel to a seed layer station for deposition of the seed layer, typically NiAl. Subsequent to the deposition of the sub-seed layer and the seed layer, the media substrates are passed through the underlayer deposition station wherein the underlayer is deposited. The media are then passed to the magnetic layer deposition station and then to the protective carbon overcoat deposition station. Finally, the media are passed through a lubricant layer deposition station.

Almost all the manufacturing of a disk media takes place in clean rooms where the amount of dust in the atmosphere is kept very low, and is strictly controlled and monitored. After one or more cleaning processes on a non-magnetic substrate, the substrate has an ultra-clean surface and is ready for the deposition of layers of magnetic media on the substrate. The apparatus for depositing all the layers needed for such media could be a static sputter system or a pass-by system, where all the layers except the lubricant are deposited sequentially inside a suitable vacuum environment.

Each of the layers constituting magnetic recording media of the present invention, except for a carbon overcoat and a lubricant topcoat layer, may be deposited or otherwise formed by any suitable physical vapor deposition technique (PVD), e.g., sputtering, or by a combination of PVD techniques, i.e., sputtering, vacuum evaporation, etc., with sputtering being preferred. The carbon overcoat is typically deposited with sputtering or ion beam deposition. The lubricant layer is typically provided as a topcoat by dipping of the medium into a bath containing a solution of the lubricant compound, followed by removal of excess liquid, as by wiping, or by a vapor lube deposition method in a vacuum environment.

Sputtering is perhaps the most important step in the whole process of creating recording media. There are two types of sputtering: pass-by sputtering and static sputtering. In pass-by sputtering, disks are passed inside a vacuum chamber, where they are deposited with the magnetic and non-magnetic materials that are deposited as one or more layers on the substrate when the disks are moving. Static sputtering uses smaller machines, and each disk is picked up and deposited individually when the disks are not moving. The layers on the disk of the embodiment of this invention were deposited by static sputtering in a sputter machine.

The sputtered layers are deposited in what are called bombs, which are loaded onto the sputtering machine. The bombs are vacuum chambers with targets on either side. The substrate is lifted into the bomb and is deposited with the sputtered material.

A layer of lube is preferably applied to the carbon surface as one of the topcoat layers on the disk.

Sputtering leads to some particulates formation on the post sputter disks. These particulates need to be removed to ensure that they do not lead to the scratching between the head and substrate. Once a layer of lube is applied, the substrates move to the buffing stage, where the substrate is polished while it preferentially spins around a spindle. The disk is wiped and a clean lube is evenly applied on the surface.

Subsequently, in some cases, the disk is prepared and tested for quality thorough a three-stage process. First, a burnishing head passes over the surface, removing any bumps (asperities as the technical term goes). The glide head then goes over the disk, checking for remaining bumps, if any. Finally the certifying head checks the surface for manufacturing defects and also measures the magnetic recording ability of the disk.

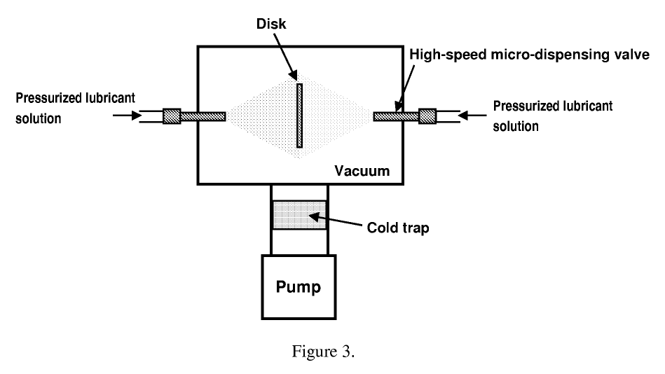

The invention involves vapor deposition of lubricant and lubricant additives on thin film medium. A lubricant solution containing lubricant(s) and lubricant additive(s), such as X-1p, is sprayed into ultra-fine droplets as small as a few microns or submicron in diameter through a micro-dispensing valve into the process chamber under vacuum as shown in FIG. 3. As shown in FIG. 3, a micro/nano-liter dispensing valve is used to generate a spray in the vacuum chamber with a fixed volume of lube/solvent solution at a high pressure. With the solvent being evaporated and pumped out, a uniformly layer of lubricant will deposit onto the disk surface. Since each time the lubricant solution dispensed by the valve has the same MW and component distributions, each disk will have the same MW and component distributions that are close to those of the source lube. To reduce the solvent usage, a cold trap can be put inside the vacuum chamber or at the exhaust line to collect the solvent for re-usage.

While FIG. 3 does not show any baffles between the media and the vacuum chamber, optionally such baffles could be incorporated within the vacuum chamber of FIG. 3. While not shown in FIG. 3, the lubricant is pumped from the pressuring pump to the high-speed micro-dispensing valve, which could include a micro-dispensing valve and a valve such as a solenoid valve for flow control with a programmable controller for the solenoid valve. The flow control in FIG. 3 could be done by any input signal or feed stream to control the flow of the lubricant(s) and the additive(s) stream through the high-speed micro-dispensing valve.

In the deposition process using micro-dispensing valve atomization of this invention, the low boiling point lubricant solvent in the droplets, such as Vertrel Xf, evaporates rapidly under vacuum. The fast evaporation of lubricant solvent breaks down the droplets quickly, and thus vaporizes or atomizes the PFPE lubricant in the process chamber completely. A substantially uniform deposition of the lubricant(s) and lubricant additive(s) on medium surface can be achieved thereafter. The term “atomization” refers to the breaking down of a liquid into droplets that can be suspended in a gas. The phrase “substantially uniform” means that there is little variation (less than 5%) in concentration of a component from one point to another point on the surface of the disc recording medium that could impact the performance of the disc drive.

The lubricant(s) reaches its vapor pressure after atomization. The collision rate of lubricant molecules on medium surface, S, follows a relation: S=P/2πmkT, where P and m are the vapor pressure and molecular weight of a PFPE lubricant, respectively. For a Zdol PFPE of a molecular weight of 2000 amu, its vapor pressure is about 2×10⁻⁵ Torr at 20° C. It takes about 0.32 sec to deposit a 10 Å lubricant film on medium surface. Thus, the deposition of the lubricant(s) and the additive(s) could be completed within 5 seconds, more preferably within 1 second, exposure of the medium surface to the vapor of the lubricant(s) and additive(s).

In FIG. 3, even though the atomization chamber is labeled as “Vacuum [chamber],” which is the preferred embodiment, the atomization chamber does not necessarily have to be under a vacuum. The pressure of the gaseous environment in the atomization chamber should be such that the atomization apparatus of this invention produces droplets of the liquid entering the nozzle such that at least a portion of the droplets can be suspended in the gaseous environment of the chamber. The size of the droplets is in the range of 0.1 to 10 micrometer, preferably in the range of 0.1 to 1 micrometer, and most preferably in the range of 0.1 to 0.5 micrometer.

The advantages of the atomization vapor lube process are the following. No heating is required, so that there is no thermal degradation of lube over time. The composition of lube deposited on disks is substantially the same as that in the solution. Therefore, it can deposit multiple composition at the same time in the same chamber. Since the lube is deposited at room temperature, there is no need to control the lube bath temperature. The parameter to controll the deposition rate is the vacuum pressure, which can be easily set at a constant level. In general, the design of this invention addresses all the problems encountered in a thermal vaporization system.

In one variation, the medium could be irradiated with UV before or during the exposure of the medium to the vapor in the atomization chamber. The UV exposure could result in an increase in bonded lube thickness. The inventors have found that the amount of C—O and C═O bonds on carbon surface increases after UV exposure, which suggests that the ozone generated during the UV irradiation process reacts with the carbon surface to form functional groups such as COOH and C—OH. The strong dipole-dipole interaction between carboxyl and hydroxyl end groups bonded lube to the carbon surface is thus formed.

The lubricants that could be applied to recording media by the apparatus of this invention include polyfluoroether compositions that may be terminally functionalized with polar groups, such as hydroxyl, carboxy, or amino. The polar groups provide a means of better attaching or sticking the lubricant onto the surface of the recording media. These fluorinated oils are commercially available under such trade names as Fomblin Z®, Fomblin Z-Dol®, Fomblin Ztetraol®, Fomblin Am2001®, Fomblin Z-DISOC® (Montedison); Demnum® (Daikin) and Krytox® (Dupont). The chemical structures of some of the Fomblin lubricants are shown below.

X—CF₂—[(OCF₂—CF₂)ₘ—(OCF₂)ₙ]—OCF₂—X

Fomblin Z: Non-reactive end groups

X═F

Fomblin Zdol: Reactive end groups

X═CH₂—OH

Fomblin AM2001: Reactive end groups

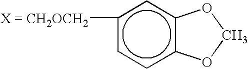

Fomblin Ztetraol: Reactive end groups

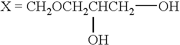

The solvents that could be used in the atomization apparatus of this invention include Vertrel XF, HFE7100, PF5060 and Ak 225.

The additives that could be added to the lubricants in this invention include X1-p and its derivatives. The thickness of the lubricant coating should be at least 0.5 nm, preferably at least 1 nm, and more preferably at least 1.2 nm and will generally be below 3 nm, preferably in the range from 1 nm to 3 nm. Molecular weight components of particular interest that provide higher film thickness range from 1 kD to 10 kD, preferably from 2 kD to 8 kD.

One way of describing a distribution of molecular components of a polymer, i.e., polydispersity, is to compare the weight average molecular weight defined as

M_{w}=ΣmᵢMᵢ/Σmᵢ

where mᵢ is the total mass of molecular component in the polymer having a molecular weight Mᵢ, with the number average molecular weight defined as

Mₙ=ΣNᵢMᵢ/ΣNᵢ

where Nᵢ is the total number of each molecular component in the polymer having a molecular weight Mᵢ. The weight average molecular weight (M_{w}) of a polymer will always be greater than the number average molecular weight (Mₙ), because the later counts the contribution of molecules in each class Mᵢ and the former weighs their contribution in terms of their mass. Thus, those molecular components having a high molecular weight contribute more to the average when mass rather than number is used as the weighing factor.

For all polydisperse polymers the ratio M_{w}/Mₙ is always greater than one, and the amount by which this ratio deviates from one is a measure of the polydispersity of the polymer. The larger the M_{w}/Mₙ ratio the greater the breadth of the molecular weight distribution of the polymer.

The molecular weight distribution of the vapor phase can be sampled by condensation of the vapor onto a suitable surface, followed by analysis of the condensate in a calibrated size exclusion chromatography system.

It is desirable that the fresh lubricant has a relatively narrow molecular weight distribution of molecular components. In practice, the narrower the distribution the easier it will be to maintain a steady-state concentration of one or more components in the vapor. For example, if the highest and lowest molecular weight components in the polymer have very similar molecular weights, their vapor pressures will also be very similar. On the other hand, if the molecular weights (vapor pressures) are dramatically different heating of the lubricant will require much greater temperature and process control for a steady state concentration to be maintained. The lubricant used in the invention should have an M_{w}/Mₙ ratio between 1 and 1.6, preferably between 1 and 1.3, more preferably between 1 and 1.2.

The invention can be practiced with any commercial lubricant with a relatively large or small polydispersity, or with a lubricant that has been pre-fractionated to obtain a lubricant with a relatively small polydispersity. The preferred embodiment of the invention does not involve pre-fractionation of the lubricant. However, pre-fractionated lubricants may be used to provide relatively narrow molecular weight lubricant. If a pre-fractionated lubricant is used in the invention, distillation, chromatography, extraction, or other techniques that allow separation can obtain the pre-fractionated lubricant by molecular weight.

### EXAMPLES

One embodiment of the invention is described below

A vaccum spray experiment with a high speed micro-dispensing valve, which can be opened for a minimum time in the range of microseconds and can dispense precisely the same amount of liquid in an amount of a micro/nano-liter each time, was made and tested.

The micro-dispensing valve was procured from the Lee Company. The details of the valve are available on the Internet at (http://www.theleeco.com/EFSWEB2.NSF/4c8c908c6ad08610852563a9005dae17/495b9 554ac723c4d85256783006alf83!OpenDocument). The model of the valve used in the embodiments of the invention is—High-speed Micro-dispensing valve (INKX0514300A).

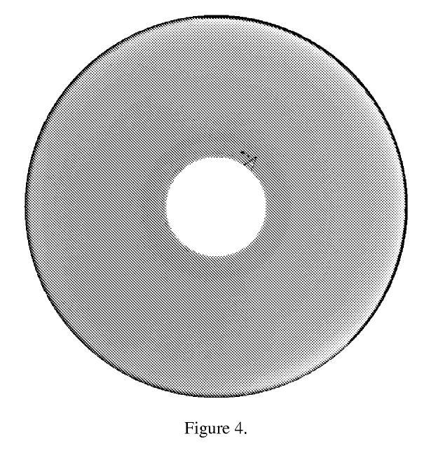

The lube solution used was 0.005 wt % Zdol-TX in Vertrel XF. FIG. 4 shows the HDI image of a disk coated with a spray in vacuum with 5 sec opening of the valve. The average lube thickness from FTIR is about 12 Å. The lubricant thickness can be controlled by adjusting the lubricant concentration, the valve open duration, and the pressure of the lubricant solution. The thickness and composition were measured by FTIR.

This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference. The implementations described above and other implementations are within the scope of the following claims.

What is claimed is:

1. A processing equipment for manufacturing magnetic recording medium comprising a chamber, a micro-dispensing valve that can open for a minimum time of less than 0.3 microseconds and can dispense a liquid in an amount of about 100 nanoliter- to about 500 micro-liter each time that the micro-dispensing valve is opened, wherein the liquid comprising a lubricant and a solvent different from the lubricant is dispensed through the micro-dispensing valve.

2. The processing equipment of claim 1, further comprising a pressurizing device for pressurizing the liquid prior to entering the micro-dispensing valve.

3. The processing equipment of claim 1, further comprising a flow controller between the pressurizing device and the micro-dispensing valve.

4. The processing equipment of claim 1, wherein the micro-dispensing valve dispenses the liquid by breaking down at least a portion of the liquid into droplets that are suspended in a gas in the chamber, and a pressure of the gas in the chamber is maintained such that the pressure is less than a vapor pressure of the liquid, wherein the droplets have a diameter in a range of 0.1 to 10 micrometer.

5. The processing equipment of claim 1, wherein substantially all of the liquid breaks down into the droplets.

6. The processing equipment of claim 1, wherein the liquid further comprises an additive and the chamber is not heated.

7. The processing equipment of claim 6, wherein the composition of the droplets is substantially the same as the composition of the liquid.

8. The processing equipment of claim 6, wherein the lubricant has a polydispersity index of more than 1.

9. The processing equipment of claim 6, wherein the additive comprises a fluorinated oil.

10. The processing equipment of claim 6, wherein a path of the droplets from the micro-dispensing valve to the holder is a line-of-sight path.

11. A method of manufacturing magnetic recording medium in an apparatus comprising a chamber, a micro-dispensing valve attached to the vacuum chamber and a holder for the medium in the chamber, wherein the method comprises atomizing a liquid comprising a lubricant and a solvent different from the lubricant through the micro-dispensing valve by breaking down at least a portion of the liquid into droplets that are suspended in a gas in the chamber, and pressurizing the gas in the chamber such that the pressure is less than a vapor pressure of the liquid, wherein the micro-dispensing valve can open for a minimum time of less than 0.3 microseconds and can dispense a liquid in an amount of about 100 nanoliter to about 500 micro-liter each time that the micro-dispensing valve is opened.

12. The method of claim 11, further pressurizing the liquid prior to entering the micro-dispensing valve.

13. The method of claim 11, further controlling a flow rate of the liquid prior to entering the micro-dispensing valve.

14. The method of claim 11, wherein the liquid comprises multiple lubricants of different compositions.
